(19) United States
(12) Patent Application Publication
(10) Pub. No.: US 2015/0283410 A1
(43) Pub. Date: Oct. 8, 2015

(54) RESPIRATOR MASK

(71) Applicant: Peter Mueller, Oakland, CA (US)

(72) Inventor: Peter Mueller, Oakland, CA (US)

(21) Appl. No.: 14/680,030

(22) Filed: Apr. 6, 2015

Related U.S. Application Data
(60) Provisional application No. 61/976,113, filed on Apr. 7, 2014.

(51) Int. Cl. A62B 23/02; A62B 18/02; A62B 18/10; A62B 7/10

(52) U.S. Cl. CPC A62B 23/025; A62B 7/10; A62B 18/02; A62B 18/10

(57) ABSTRACT

A strapless respirator mask is disclosed. The strapless respirator mask comprises a cover plate defining a set of ventilation ports for air intake and a set of outlet ports for exhalation wherein the cover plate is affixed to a filter body defining a curvature of a first value; and a mouth piece coupled to the filter body, the mouth piece extending outward from the filter body and defining a curvature of a second value that substantially matches the curvature of the filter body. The respirator mask further houses an exhale valve and at least one filter pack.

### RELATED APPLICATIONS

This application claims benefit of priority to U.S. Provisional Patent Application No. 61/976,113 entitled “RESPIRATOR MASK” filed Apr. 7, 2014, the aforementioned priority application being hereby incorporated by reference in its entirety.

### TECHNICAL FIELD

The present invention relates in general to a breathing apparatus and, more particularly, to a respirator mask which is placed within the mouth of an individual to filter the incoming air and/or exhaled breath of the individual.

### BACKGROUND

It is well known that a respirator mask is used in contaminated or polluted environments where toxic materials are in the air. Typically, the respirator mask is designed to be worn around the head of a person and includes a strap for securing the mask to the person's head. However, this type of design for a respirator mask may be uncomfortable to wear for prolonged periods of time. Additionally, existing designs for respirator masks may be cumbersome and/or heavy to wear. Therefore, a need exists for a strapless respirator mask that is simple and light weight to use.

### SUMMARY

A strapless respirator mask is disclosed. The strapless respirator mask comprises a cover plate defining a set of ventilation ports for air intake and a set of outlet ports for exhalation wherein the cover plate is affixed to a filter body defining a curvature of a first value; and a mouth piece coupled to the filter body, the mouth piece extending outward from the filter body and defining a curvature of a second value that substantially matches the curvature of the filter body. The respirator mask further houses an exhale valve and at least one filter pack.

### BRIEF DESCRIPTION OF THE DRAWINGS

Several embodiments of a respirator mask are set forth in the following figures.

FIG. 1 illustrates an exploded view of a respirator mask in accordance with some embodiments.

FIGS. 2A through 2F and 3A through 3D illustrate various views of a first version of a respirator mask in accordance with some embodiments.

FIGS. 4A through 4F and 5A through 5D illustrate various views of a second version of a respirator mask in accordance with some embodiments.

FIGS. 6A through 6F and 7A through 7D illustrate various views of a third version of a respirator mask in accordance with some embodiments.

FIGS. 8A through 8F and 9A through 9D illustrate various views of a fourth version of a respirator mask in accordance with some embodiments.

FIGS. 10A through 10E illustrates various views of a fifth version of a respirator mask in accordance with some embodiments.

FIGS. 11 through 14 illustrates various front views of other versions of a respirator mask in accordance with some embodiments.

FIGS. 15 and 16 is a side and corresponding cross-sectional view of yet another version of a respirator mask in accordance with some embodiments.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details.

### Example Exploded View of a Respirator Mask

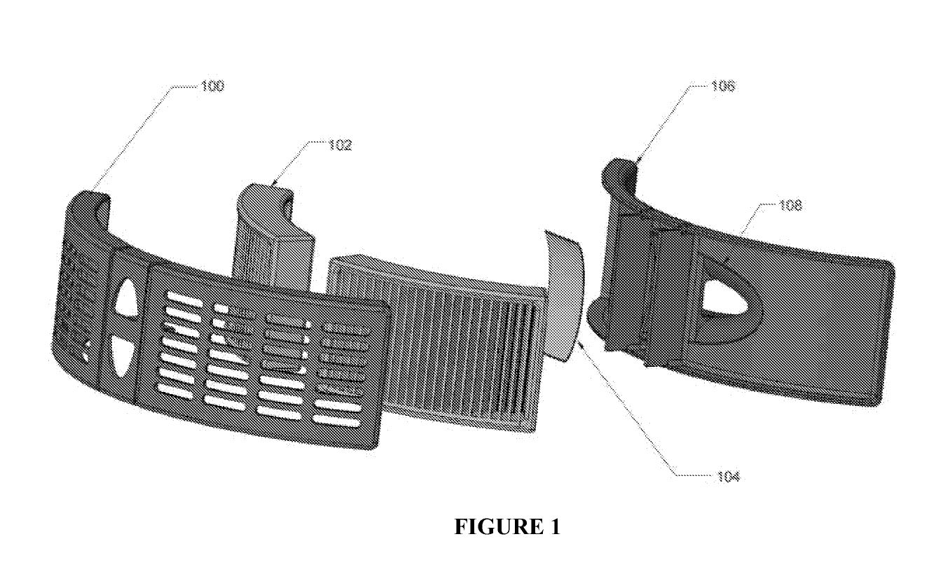

FIG. 1 illustrates an example exploded view of a respirator mask in accordance with some embodiments. As illustrated, the respirator mask includes a cover plate 100, a set of filter packs 102, an exhale valve 104, a filter body 106 and a mouth piece 108. The cover plate 100 includes a pattern of ventilation ports for air intake which enables incoming air to be filtered through the set of filter packs 102. The exhale valve 104 enables air outtake through a set of outlet ports positioned substantially at the center of the cover plate 100. In some embodiments, the exhale valve comprises a elastomeric material (or any other thin and flexible material), which is able to resume its original shape when a deforming force is removed. The filter body 106, as shown, includes a set of flanges (e.g., a jutting rib of some type) to fit the exhale value 404 and secure the set of filter packs 102. It is appreciated that any appropriate type of filter pack(s) with varying filtering properties or capabilities may be utilized and still be within the scope of the subject technology.

### Example Respirator Mask—First Version

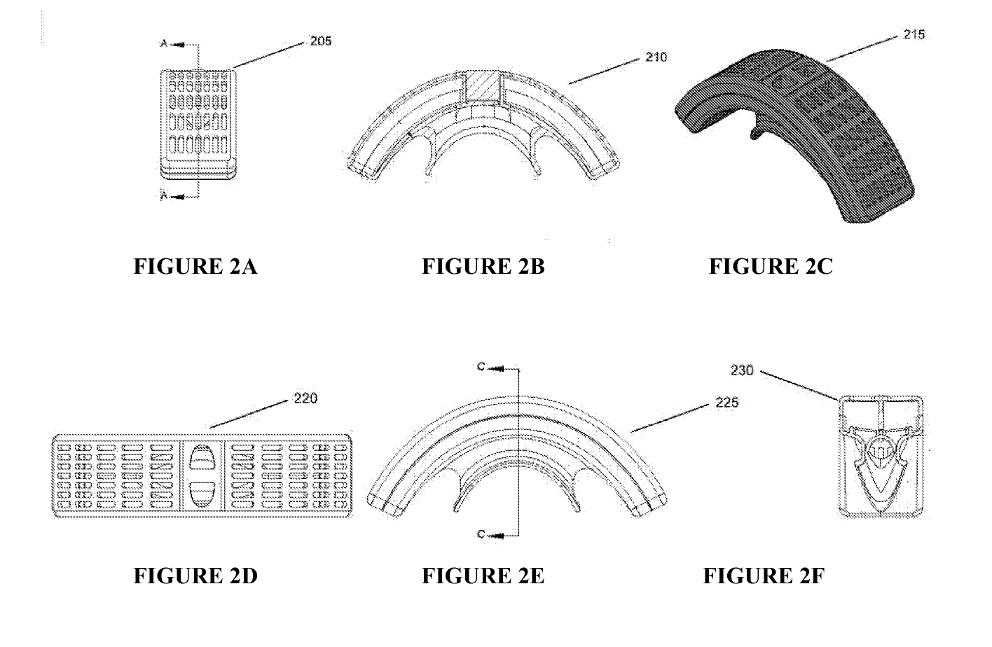

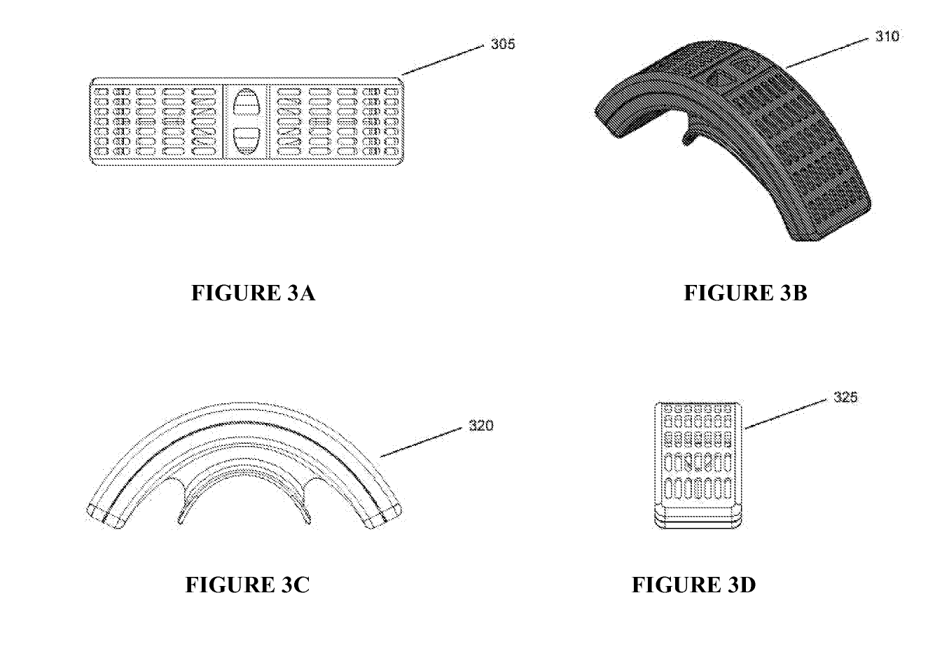

FIGS. 2A through 2F and 3A through 3D illustrate various views of a first version of a respirator mask in accordance with some embodiments. A side view 205 of a the respirator mask, a bottom view 210 of the respirator mask, a perspective view 215 of the respirator mask, a front view 220 of the respirator mask, a top view 225 of the respirator mask, and a cross-sectional view 230 of the respirator mask are shown in FIGS. 2A through 2F. A front view 305 of the respirator mask, a perspective view 310 of the respirator mask, a top view 320 of the respirator mask, and a side view 325 of the respirator mask are shown in 3A through 3D.

As illustrated in the various views 210, 225 and 320, it is appreciated that the respirator mask includes an exterior housing that exhibits a curvature that allows the respirator mask to substantially conform to a face of a person when the respirator mask is fitted. Additionally, the respirator mask includes a curved mouth piece as can be seen in the views 210, 225 and 320 that is adapted to engage with a mouth of a person. The mouth piece extends outwardly from the filter body of the respirator.

### Example Respirator Mask—Second Version

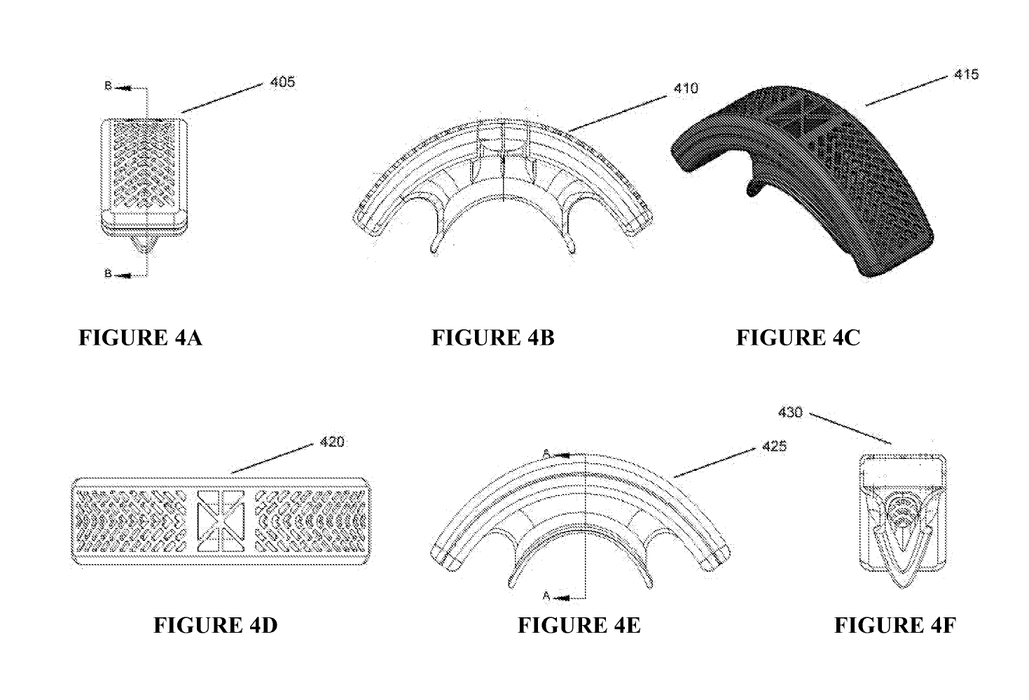

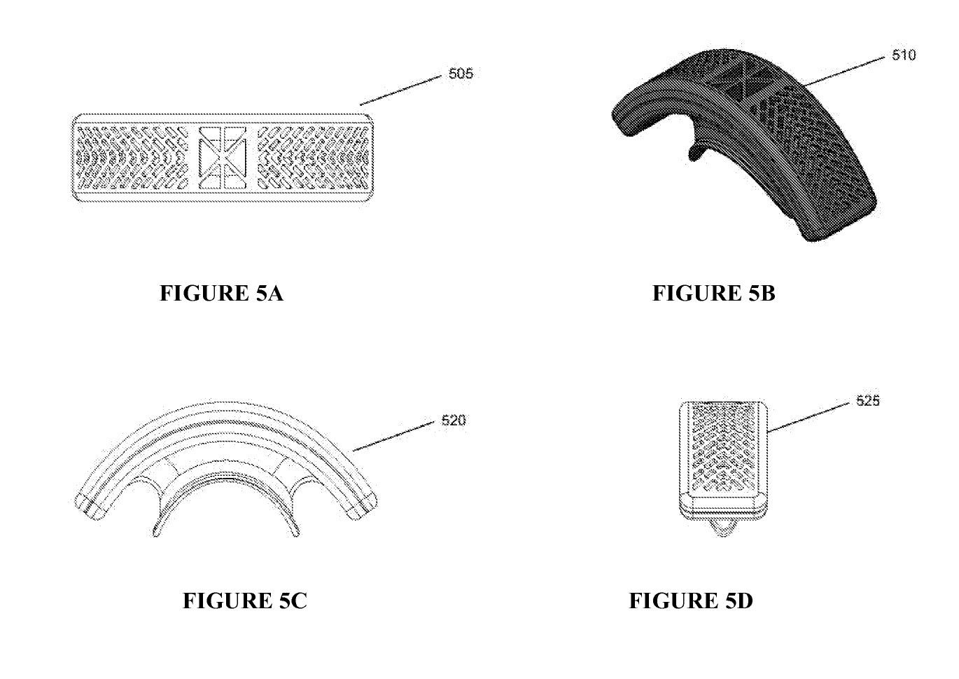

FIGS. 4A through 4F and 5A through 5D illustrate various views of a second version of a respirator mask in accordance with some embodiments. A side view 405 of a the respirator mask, a bottom view 410 of the respirator mask, a perspective view 415 of the respirator mask, a front view 420 of the respirator mask, a top view 425 of the respirator mask, and a cross-sectional view 430 of the respirator mask are shown in 4A through 4F. A front view 505 of the respirator mask, a perspective view 510 of the respirator mask, a top view 520 of the respirator mask, and a side view 525 of the respirator mask are shown in 5A through 5D.

The respirator mask as illustrated in 4A through 4F and 5A through 5D include a set of ventilation ports in a configuration that is different than the respirator mask illustrated in FIGS. 2A through 2F and 3A through 3D.

### Example Respirator Mask—Third Version

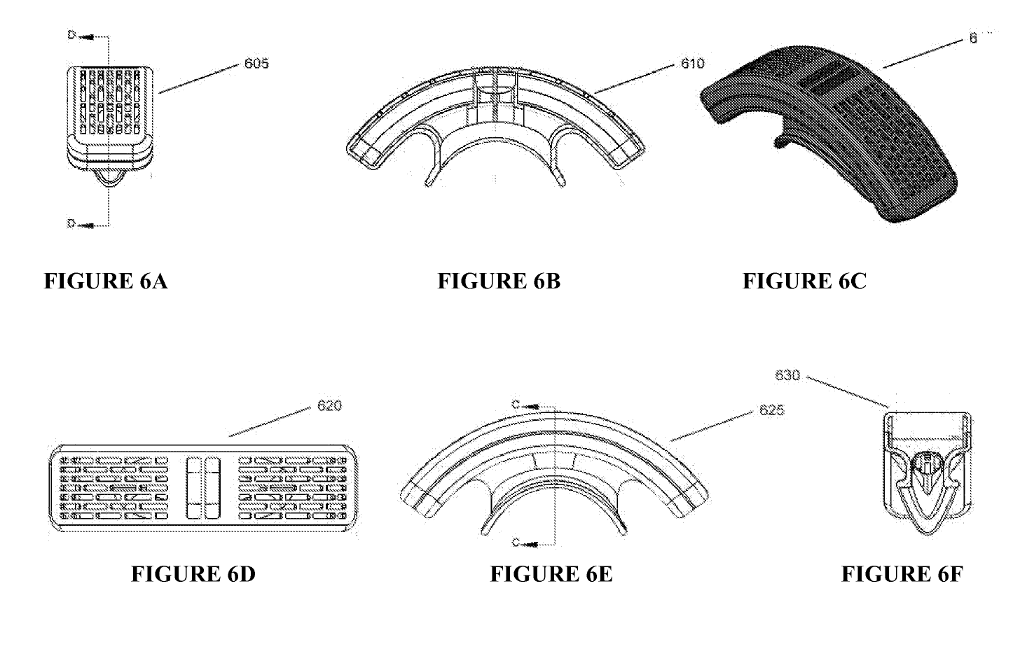

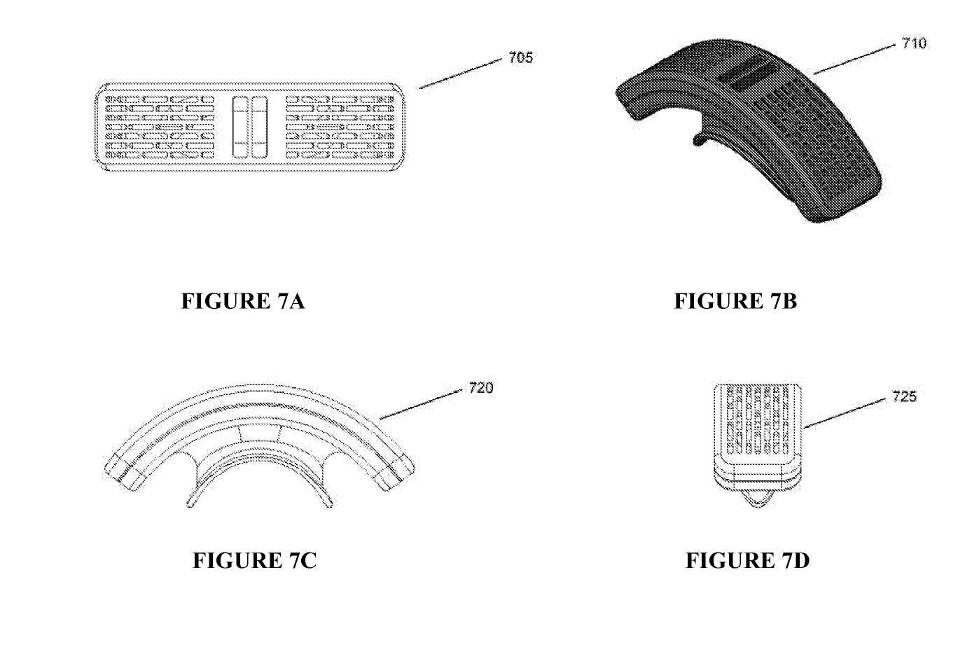

FIGS. 6A through 6F and 7A through 7D illustrate various views of a third version of a respirator mask in accordance with some embodiments. A side view 605 of a the respirator mask, a bottom view 610 of the respirator mask, a perspective view 615 of the respirator mask, a front view 620 of the respirator mask, a top view 625 of the respirator mask, and a cross-sectional view 630 of the respirator mask are shown in FIGS. 6A through 6F. A front view 705 of the respirator mask, a perspective view 710 of the respirator mask, a top view 720 of the respirator mask, and a side view 725 of the respirator mask are shown in FIGS. 7A through 7D.

The respirator mask as illustrated in FIGS. 6A through 6F and FIGS. 7A through 7D include a set of ventilation ports in a configuration that is different than the respirator masks illustrated in FIGS. 2 through 5.

### Example Respirator Mask—Fourth Version

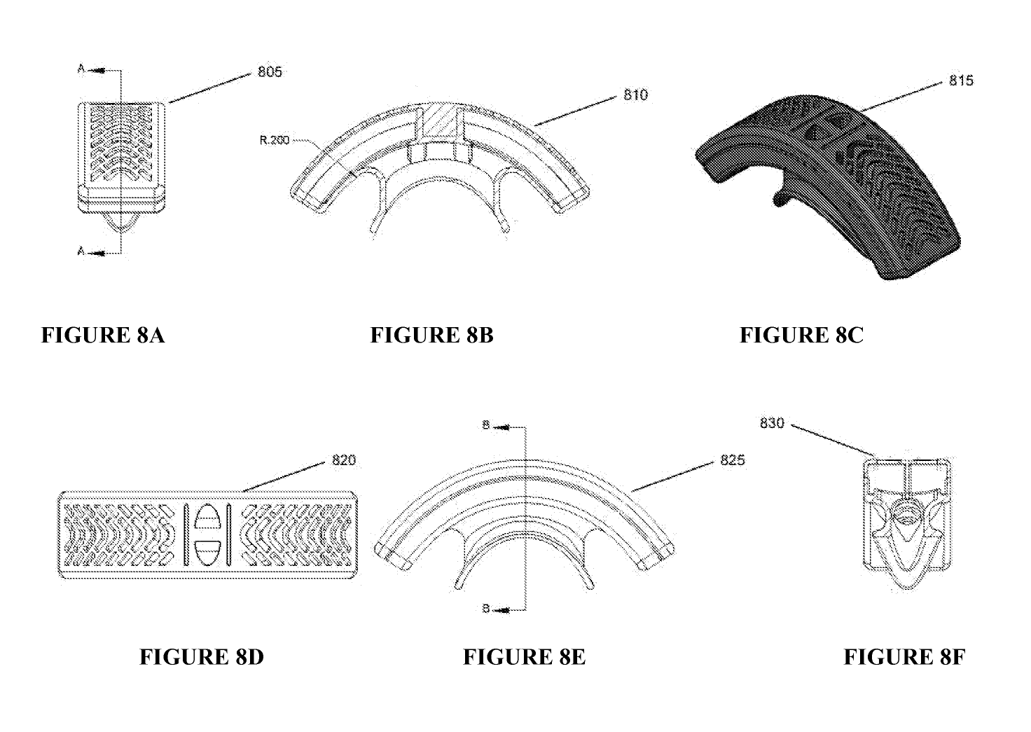

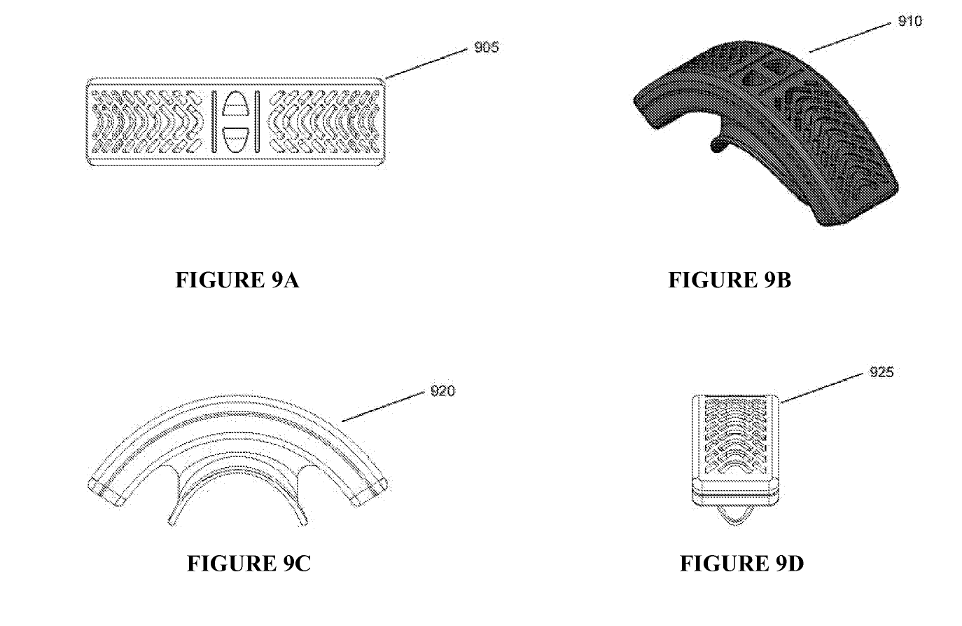

FIGS. 8A through 8F and FIGS. 9A through 9D illustrate various views of a fourth version of a respirator mask in accordance with some embodiments. A side view 805 of a the respirator mask, a bottom view 810 of the respirator mask, a perspective view 815 of the respirator mask, a front view 820 of the respirator mask, a bottom view 825 of the respirator mask, and a cross-sectional view 830 of the respirator mask are shown in FIGS. 8A through 8F. A front view 905 of the respirator mask, a perspective view 910 of the respirator mask, a top view 920 of the respirator mask, and a side view 925 of the respirator mask are shown in FIGS. 9A through 9D.

The respirator mask as illustrated in FIGS. 8A through 8F and FIGS. 9A through 9D include a set of ventilation ports in a configuration that is different than the respirator masks illustrated in FIGS. 2 through 7.

### Example Respirator Mask—Fifth Version

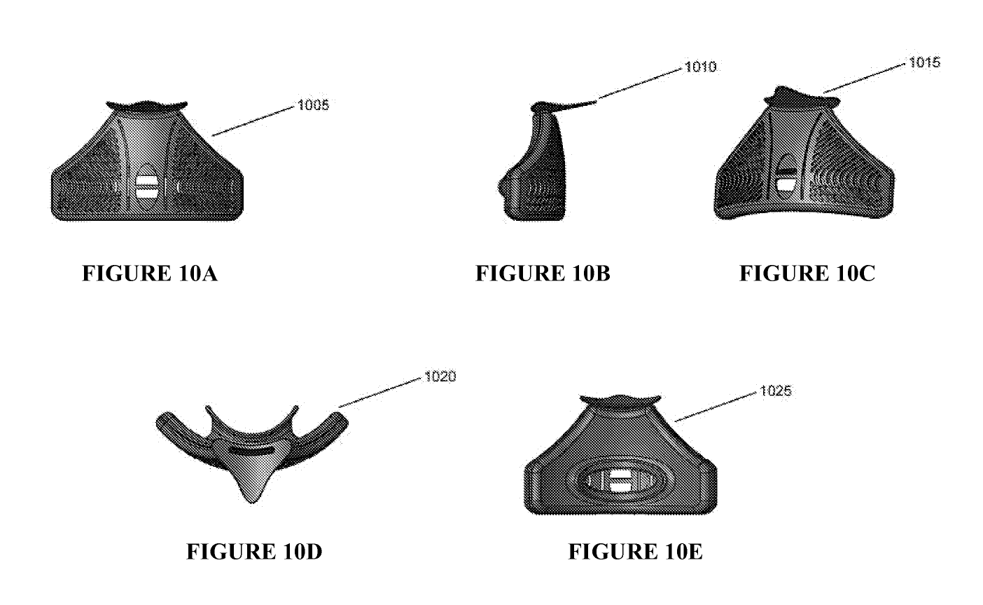

FIGS. 10A through 10E illustrates various views of a fifth version of a respirator mask in accordance with some embodiments. A front view 1005 of a the respirator mask, a side view 1010 of the respirator mask, a perspective view 1015 of the respirator mask, a top view 1020 of the respirator mask, and a rear view 1025 of the respirator mask are shown in FIGS. 10A through 10E.

The respirator mask of FIGS. 10A through 10E includes a different filter body than the respirator masks illustrated in FIGS. 1 through 9. Additionally, the set ventilation ports in FIG. 10A. FIGS. 10A through 10E are different than the respirator masks illustrated in FIGS. 1 through 9.

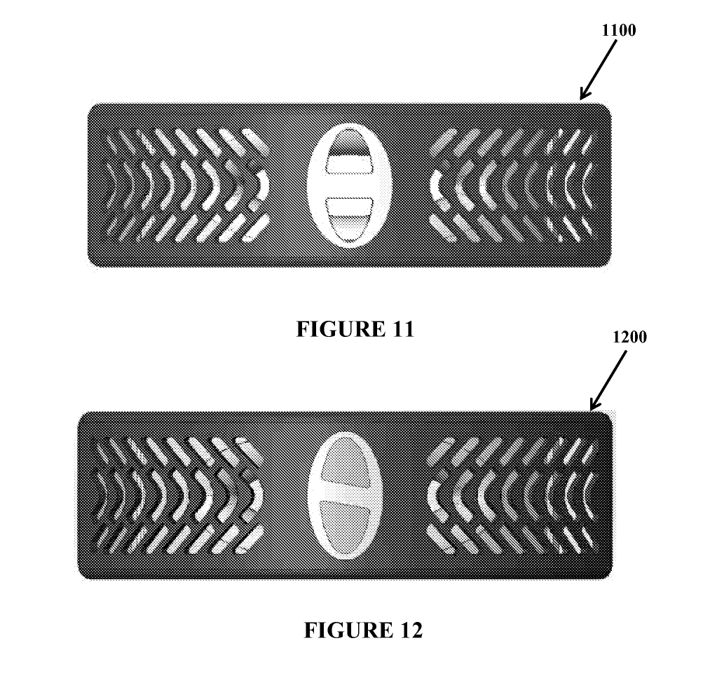

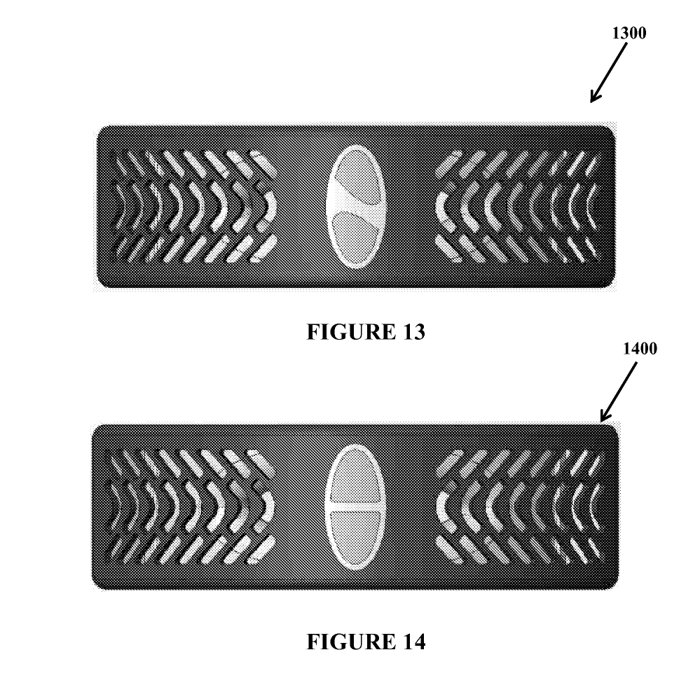

FIGS. 11 through 14 illustrates various front views, 1100, 1200, 1300 and 1400 respectively of other versions of a respirator mask in accordance with some embodiments. It should be understood that in any of the afore-described respirators, a tapered air channel may be provided for filtered air to pass through, wherein the tapered air channel optimizes the space and air flow resistance, providing greater efficiency to the filter. Additionally, a connection point between the exhale valve, and filtered air intake is provided, wherein the proximity of the filtered air intake (right and left of the exhale valve) is a KEY feature in this design.

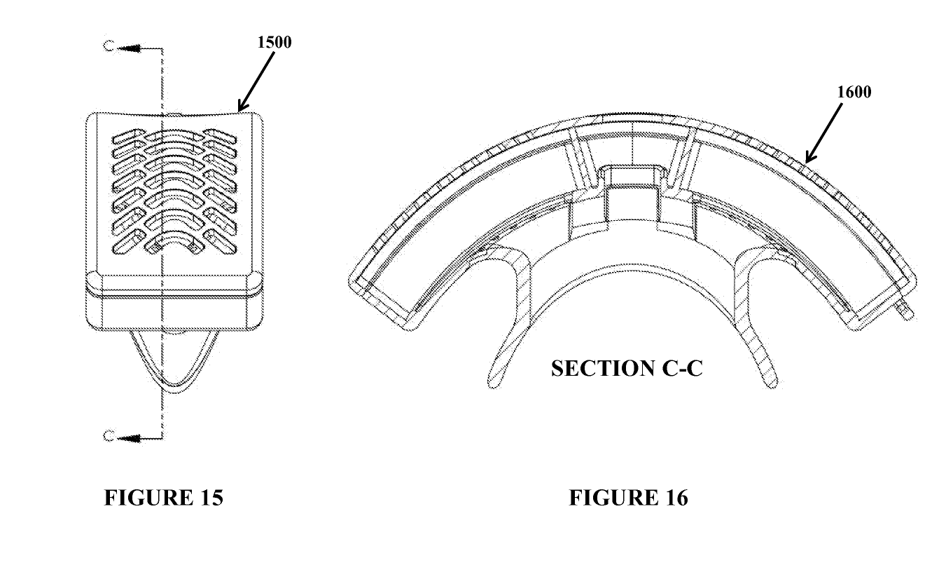

Referring now to FIGS. 15 and 16 there is shown a side and corresponding cross-sectional view 1500 and 1600 respectively of yet another version of a respirator mask and illustrates a different angled exhale valve walls than was previously shown and described in FIGS. 1 through 14. More particularly, instead of the exhale walls being parallel they are angled to optimize the space relation between the filtered air intake and exhale valve.

The previous description is provided to enable a person skilled in the art to practice the various aspects described herein. Various modifications to these aspects will be readily apparent to those skilled in the art, and the generic principles defined herein can be applied to other aspects. Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

What is claimed is:

1. A respirator mask comprising:
a cover plate;
a filter body coupled to the cover plate, the filter body having curvature of a first value; and
and a mouth piece coupled to the filter body, the mouth piece extending outward from the filter body and having a curvature of a second value that substantially matches the curvature of the filter body.

2. The respirator mask of clause 1, further comprising:
an exhale valve.

3. The respirator mask of clause 1, further comprising:
at least one filter pack.

4. The respirator mask of clause 1, wherein the cover plate comprises a set of ventilation ports for air intake and a set of outlet ports for exhalation.

5. The respirator mask of clause 1, further comprising:
a tapered air channel for filtered air to pass through,

6. The respirator mask of clause 1, further comprising:
a tapered air channel optimizes the space and air flow resistance, providing greater efficiency to the filter.

7. The respirator mask of clause 2, further comprising:
a connection point between the exhale valve, and a filtered air intake wherein the filtered air intake is proximally located right and left of the exhale valve.

8. The respirator mask of clause 8, further comprising: exhale walls angled to optimize a space relation between the filtered air intake and exhale valve.
